(19) United States
(12) Patent Application Publication
(10) Pub. No.: US 2023/0174811 A1
(43) Pub. Date: Jun. 8, 2023

(54) INK SET, PRINTED MATTER, PRINTING METHOD, AND PRINTING DEVICE

(71) Applicants: Naoto SHIMURA, Tokyo (JP); Yuusuke Koizuka, Shizuoka (JP)

(72) Inventors: Naoto SHIMURA, Tokyo (JP); Yuusuke Koizuka, Shizuoka (JP)

(73) Assignee: Ricoh Company, Ltd., Tokyo (JP)

(21) Appl. No.: 17/999,044

(22) PCT Filed: Jun. 22, 2021
(86) PCT No.: PCT/IB2021/055472

§ 371 Date: Nov. 16, 2022

(30) Foreign Application Priority Data
Jul. 22, 2020 (JP) 2020-125094
Apr. 7, 2021 (JP) 2021-065240

(51) Int. Cl. C09D 11/40; C09D 11/322; C09D 11/38; D06P 5/30

(52) U.S. Cl. CPC C09D 11/40; C09D 11/38; C09D 11/322; D06P 5/30

(57) ABSTRACT

A printing method prints an image on a leather with an ink set including a color ink and a clear ink. The printing method includes: applying the clear ink to a region of the leather where the color ink is to be applied; applying the color ink onto the clear ink applied; and applying the clear ink onto the color ink applied.

### TECHNICAL FIELD

The present disclosure relates to an ink set, a printed matter, a printing method, and a printing device.

### BACKGROUND ART

In response to demands for decoration of various designs, there has recently been an increased tendency to rely on inkjet methods. Other reasons for this tendency are that processes of the inkjet methods are simpler than in other printing methods, formation of a full-color image is easy, and the inkjet methods are applicable to various printing targets including a leather even in a device having a simple structure to obtain a high-resolution image.

The inkjet methods use, for example, an aqueous ink, a solvent ink, or an ultraviolet ray-curable ink (UV ink). For permeable leathers such as a tanned leather, an aqueous ink or a solvent ink can be used. For a poorly- or non-permeable leather having a surface treated with, for example, a resin, abnormal images such as color bleeding and beading may occur.

A UV ink is used for, for example, a wide variety of leathers (see, for example, PTLs 1 and 2). Meanwhile, a latex ink can decorate a wide variety of leathers and form an ink coating that is more flexible and safer than in the UV ink (see, for example, PTL 3).

### CITATION LIST

### Patent Literature

PTL 1] Japanese Unexamined Patent Application Publication No. 2014-55210-A
PTL 2] International Publication No. WO2017/104318
PTL 3] Japanese Unexamined Patent Application Publication No. 2019-77070-A

### SUMMARY OF INVENTION

### Technical Problem

The present disclosure has an object to provide a printing method that can print on a leather an image excellent in fixability and scratch resistance without degrading the textures of the original leather.

### Solution to Problem

According to one aspect of the present disclosure, a printing method prints an image on a leather with an ink set including a color ink and a clear ink. The color ink includes a coloring material, an organic solvent, and a resin. The clear ink includes an organic solvent, an acrylic resin, and a urethane resin. The printing method includes: a first clear ink applying step of applying the clear ink to a region of the leather where the color ink is to be applied; a color ink applying step of applying the color ink onto the first clear ink applied; and a second clear ink applying step of applying the clear ink onto the color ink applied.

### Advantageous Effects of Invention

According to the present disclosure, it is possible to provide a printing method that can print on a leather an image excellent in fixability and scratch resistance without degrading the textures of the original leather.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a perspective view illustrating an example of the printing device.

FIG. 2 is a perspective view illustrating an example of the main tank in the printing device.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

In the present disclosure, the term “image” includes the concepts of ordinary images, texts, geometric patterns, etc., and is not limited to particular type of image.

### Printing Method and Printing Device

The printing method of the present disclosure is a printing method that prints an image on a leather with an ink set including a color ink and a clear ink. The color ink includes a coloring material, an organic solvent, and a resin. The clear ink includes an organic solvent, an acrylic resin, and a urethane resin. The printing method includes: a first clear ink applying step of applying the clear ink to a region of the leather where the color ink is to be applied; a color ink applying step of applying the color ink onto the first clear ink applied; and a second clear ink applying step of applying the clear ink onto the color ink applied. If necessary, the printing method further includes other steps.

A printing device of the present disclosure is a printing device that prints an image on a leather with an ink set including a color ink and a clear ink. The color ink includes a coloring material, an organic solvent, and a resin. The clear ink includes an organic solvent, an acrylic resin, and a urethane resin. The printing device includes a color ink applying unit configured to apply the color ink and a clear ink applying unit configured to apply the clear ink. If necessary, the printing device further includes other units.

The printing method of the present disclosure can be successfully performed by the printing device of the present disclosure. The first clear ink applying step and the second clear ink applying step can be performed by the clear ink applying unit. The color ink applying step can be performed by the color ink applying unit. The other steps can be performed by the other units.

In related art, a UV ink forms a hard ink coating to easily degrade the textures of the original leather and has a concern about safety. A latex ink disadvantageously forms an image that is more easily peeled off when an ink coating is scratched, than in the UV ink. The color ink, when used alone, disadvantageously forms an image that is easily peeled off when the image on the leather is rubbed or scratched.

In the present disclosure which is directed to a printing method that prints an image on a leather with an ink set including a color ink and a clear ink, when the color ink includes a coloring material, an organic solvent, and a resin, the clear ink includes an organic solvent, an acrylic resin, and a urethane resin, and the printing method includes: a first clear ink applying step of applying the clear ink to a region of the leather where the color ink is to be applied; a color ink applying step of applying the color ink onto the first clear ink applied; and a second clear ink applying step of applying the clear ink onto the color ink applied, it is possible to increase the strength of a color ink film formed on the leather, and print on a leather an image excellent in fixability and scratch resistance without degrading textures such as smoothness and comfortable touch feelings of the leather.

The ink set used in the printing method and the printing device of the present disclosure will be described in detail below.

### Ink Set

The ink set in the present disclosure includes a color ink and a clear ink that are used for a leather as a printing target.

### Clear Ink

The clear ink includes an organic solvent, an acrylic resin, and a urethane resin; and if necessary, further includes other components.

### Organic Solvent

There is no specific limitation on the type of the organic solvent used in the clear ink. For example, water-soluble organic solvents are suitable. Specific examples thereof include, but are not limited to, polyols, ethers such as polyol alkylethers and polyol arylethers, nitrogen-containing heterocyclic compounds, amides, amines, and sulfur-containing compounds. Of these, amides are preferable in terms of imparting scratch resistance and fixability to a poorly-or non-permeable leather having a surface treated with, for example, a resin.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrolidone, N-methyl-2-pyrolidone, N-hydroxyethyl-2-pyrolidone, 1,3-dimethyl-2-imidazolidinone, ε -caprolactam, and γ -butyrolactone; amides represented by General Formula (1) below; amines such as monoethanolamine, diethanolamine, and triethylamine; sulfur-containing compounds such as dimethyl sulfoxide, sulfolane, and thiodiethanol; propylene carbonate; and ethylene carbonate.

Since the water-soluble organic solvent serves as a humectant and also imparts a good drying property, it is preferable to use an organic solvent having a boiling point of 250° C. or lower. [Chem. 1]

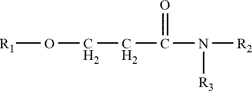

In the General Formula (1), R₁, R₂, and R₃ each independently represent a hydrocarbon group having one or more but eight or less carbon atoms.

The hydrocarbon group is not particularly limited as long as it has one or more but eight or less carbon atoms. Examples thereof include, but are not limited to, straight chain, branched, or cyclic alkyl groups.

Examples of the alkyl groups include, but are not limited to, a methyl group, an ethyl group, a propyl group, a butyl group, an isopropyl group, an isobutyl group, a pentyl group, a hexyl group, a heptyl group, an ethylhexyl group, an octyl group, a cyclopropyl group, a cyclobutyl group, a cyclopentyl group, and a cyclohexyl group.

Examples of the amides represented by the above General Formula (1) include, but are not limited to, 3-methoxy-N,N-dimethylpropionamide and 3-butoxy-N,N-dimethylpropionamide.

For the clear ink, polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycol ether compounds include, but are not limited to, polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, propylene glycol monoethyl ether; and polyol aryl ethers such as ethylene glycol monophenyl ether and ethylene glycol monobenzyl ether.

### Resin

The type of the resin has no particular limit. Specific examples thereof include, but are not limited to, urethane resin, polyester resins, acrylic-based resins, vinyl acetate-based resins, styrene-based resins, butadiene-based resins, styrene-butadiene-based resins, vinyl chloride-based resins, acrylic styrene-based resins, and acrylic silicone-based resins. Particles of such resins may be also used. It is possible to mix a resin emulsion in which the resin particles are dispersed in water serving as a dispersion medium with materials such as a coloring agent and an organic solvent to obtain ink. The resin particle can be synthesized or is available on the market. These can be used alone or in combination of the resin particles.

Of these, the clear ink includes a urethane resin and an acrylic resin in terms of fixability onto a leather.

The acrylic resin included in the clear ink preferably has a glass transition temperature Tg of 50° C. in terms of scratch resistance.

The amount of the resin is not particularly limited and may be appropriately selected depending on the intended purpose. In terms of fixability and storage stability of the clear ink, relative of the total amount of the clear ink, it is preferably 10% by mass or more but 30% by mass or less, and in terms of discharge reliability and fixability, it is more preferably 3% by mass or more but 15% by mass or less.

The particle diameter of the solid portion in the clear ink has no particular limit. For example, the maximum frequency in the maximum number conversion is preferably 20 nm or more but 1,000 nm or less and more preferably 20 nm or more but 150 nm or less, in terms of increasing, for example, dispersion stability. The particle diameter thereof can be measured using a particle size analyzer (NANOTRAC WAVE-UT151, manufactured by MicrotracBEL Corp).

### Other Components

Examples of the other components include, but are not limited to, water, surfactants, defoaming agents, preservatives and fungicides, corrosion inhibitors, and pH regulators.

### Water

The water usable is pure water and ultrapure water such as ion-exchanged water, ultrafiltration water, reverse osmosis water, and distilled water.

The amount of the water in the clear ink is not particularly limited and may be appropriately selected depending on the intended purpose. In terms of drying properties and discharge reliability of the ink, it is preferably 10% by mass or more but 90% by mass or less, more preferably 20% by mass or more but 60% by mass or less.

### Surfactant

Examples of the surfactant are silicone-based surfactants, fluorosurfactants, amphoteric surfactants, nonionic surfactants, anionic surfactants, etc.

The silicone-based surfactant has no specific limit and can be suitably selected to suit to a particular application. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant.

A specific example thereof is a compound in which a polyalkylene oxide structure is introduced into the side chain of the Si site of dimethyl siloxane.

Specific examples of the fluorosurfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorosurfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant.

Any suitably synthesized surfactant and any product thereof available on the market is suitable. Products available on the market are obtained from BYK Chemie K.K., Shin-Etsu Silicone Co., Ltd., Dow Corning Toray Co., Ltd., NIHON EMULSION Co., Ltd., Kyoeisha Chemical Co., Ltd., etc.

The polyether-modified silicone-based surfactant has no particular limit. For example, a compound in which the polyalkylene oxide structure represented by the following Chemical structure S-1 is introduced into the side chain of the Si site of dimethyl polysiloxane.

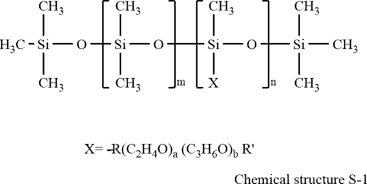

In the Chemical structure S-1, “m”, “n”, “a”, and “b” each, respectively represent integers, R represents an alkylene group, and R′ represents an alkyl group.

Specific examples of polyether-modified silicone-based surfactants include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co.,Ltd.), BYK-33 and BYK-387 (both manufactured by BYK Chemie K.K.), and TSF4440, TSF4452, and TSF4453 (all manufactured by Momentive Performance Materials Inc.).

A fluorosurfactant in which the number of carbon atoms replaced with fluorine atoms is from 2 to 16 is preferable and, 4 to 16, more preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain.

Of these, polyoxyalkylene ether polymer compounds having a perfluoroalkyl ether group in its side chain are preferable because they do not foam easily and the fluorosurfactant represented by the following Chemical formula F-1 or Chemical formula F-2 is more preferable.

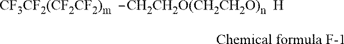

In the Chemical formula F-1, “m” is preferably 0 or an integer of from 1 to 10 and “n” is preferably 0 or an integer of from 1 to 40.

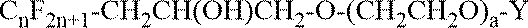

In the Chemical formula F-2, Y represents H, CₙF₂ₙ₊₁, where n represents an integer of from 1 to 6, H₂CH(OH)CH₂-CₙF₂ₙ₊₁, where n represents an integer of from 4 to 6, or CₚH₂ₚ₊₁, where p represents an integer of from 1 to 19. “a” represents an integer of from 4 to 14.

Products available on the market may be used as the fluorosurfactant.

Specific examples of the products available on the market include, but are not limited to, SURFLON S-111, SURFLON S-112, SURFLON S-113, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL™ TBS, FSP, FSA, FSN-100, FSN, FSO-100, FSO, FS-300, UR, CAPSTONE (registered trademark) FS-30, FS-31, FS-3100, FS-34, FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, PF-159 (manufactured by OMNOVA SOLUTIONS INC.), and UNIDYNE DSN-403N (manufactured by DAIKIN INDUSTRIES). Of these, FS-3100, FS-34, FS-300 (all manufactured by The Chemours Company), FT-110, FT-250, FT-251, FT-400S, FT-150, and FT-400SW (all manufactured by NEOS COMPANY LIMITED), PolyFox PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dying property to paper.

The proportion of the surfactant in ink is not particularly limited. It is preferably from 0.001 to 5 percent by mass and more preferably from 0.05 to 5 percent by mass ink in terms of excellent wettability and discharging stability.

### Defoaming Agent

The defoaming agent has no particular limit. For example, silicon-based defoaming agents, polyether-based defoaming agents, and aliphatic acid ester-based defoaming agents are suitable. These can be used alone or in combination. Of these, silicone-based defoaming agents are preferable to easily break foams.

### Preservatives and Fungicides

The preservatives and fungicides are not particularly limited. Specific examples thereof include, but are not limited to, 1,2-benzisothiazolin-3-one.

### Corrosion Inhibitor

The corrosion inhibitor has not particular limit. Specific examples thereof include, but are not limited to, acid sulfite and sodium thiosulfate.

### pH Regulator

The pH regulator has no particular limit. It is preferable to adjust the pH to 7 or higher. Specific examples thereof include, but are not limited to, amines such as diethanol amine and triethanol amine.

The property of the clear ink is not particularly limited and may be appropriately selected depending on the intended purpose. For example, viscosity, surface tension, pH, etc., are preferably in the following ranges.

The viscosity of the clear ink at 25° C. is preferably from 5 to 30 mPa·s and more preferably from 5 to 25 mPa·s to improve print density and text quality and obtain good dischargeability. The viscosity can be measured by, for example, a rotatory viscometer (RE-80L, manufactured by TOKI SANGYO CO., LTD.). The measuring conditions are as follows:
Standard cone rotor (1°34′ × R24)
Sample liquid amount: 1.2 mL
Number of rotations: 50 rotations per minute (rpm)
25° C.
Measuring time: three minutes

The surface tension of the clear ink is preferably 35 mN/m or less and more preferably 32 mN/m or less at 25° C. in terms that the ink is suitably levelized on a printing target and the drying time of the ink is shortened.

The pH of the clear ink is preferably from 7 to 12 and more preferably from 8 to 11 in terms of prevention of corrosion of metal materials contacting the clear ink.

The maximum tensile stress of a dry film of the clear ink is preferably 3.5 N/mm² or more, more preferably 5 N/mm² or more, and further preferably 8 N/mm² or more.

When the maximum tensile stress of the dry film of the clear ink is 3.5 N/mm² or more, a printed matter excellent in scratch resistance can be obtained.

The maximum tensile stress of the dry film of the clear ink is measured in the following manner. Specifically, 8 g of the clear ink is placed in a TEFLON (registered trademark) Petri dish having a diameter of 50 mm. The clear ink is dried for 2 days in a hot air circulation-type thermostat chamber of 70° C. to obtain a dry film of the clear ink. The obtained dry film of the clear ink is cut out with a cutter into a section having a size of 5 mm×50 mm. The section is subjected to a tensile test under the following measurement conditions to measure the maximum tensile stress. The average thickness of the dry film of the clear ink is an average value of measurements obtained at three or more points with a micrometer, and is from 0.3 mm through 0.8 mm.

### Measurement Conditions of Tensile Stress

Device: Autograph AG-10N available from Shimadzu Corporation
Load cell: 50 N
Tensile speed: 150 mm/min
Distance between chucks: 4 mm
Sample width: 5 mm

### Color Ink

The color ink includes a coloring material, an organic solvent, and a resin; and if necessary, further includes other components.

The color of the color ink is not particularly limited and may be appropriately selected depending on the intended purpose. Examples thereof include, but are not limited to, yellow, magenta, cyan, black, and white.

Printing with an ink set using two or more color inks in combination can form a multi-color image. Printing with an ink set using color inks of all colors can form a full-color image. The white ink is suitable for forming an underlying layer of a color image.

### Coloring Material

The coloring material has no particular limit. For example, pigments and dyes are suitable. The pigment includes inorganic pigments and organic pigments. These can be used alone or in combination. In addition, it is possible to use a mixed crystal.

As the pigments, for example, black pigments, yellow pigments, magenta pigments, cyan pigments, white pigments, green pigments, orange pigments, gloss pigments of gold, silver, etc., and metallic pigments can be used.

As the inorganic pigments, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black can be used. Of these pigments, pigments having good affinity with solvents are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, 213, C.I. Pigment Orange 5, 13, 16, 17, 36, 43, 51, C.I. Pigment Red 1, 2, 3, 5, 17, 22, 23, 31, 38, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, 264, C.I. Pigment Violet 1 (Rohdamine Lake), 3, 5:1, 16, 19, 23, 38, C.I. Pigment Blue 1, 2, 15 (Phthalocyanine Blue), 15:1, 15:2, 15:3, 15:4 (Phthalocyanine Blue), 16, 17:1, 56, 60, 63, C.I. Pigment Green 1, 4, 7, 8, 10, 17, 18, and 36.

The type of dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in the color ink is preferably 0.1% by mass or more but 15% by mass or less, more preferably 1% by mass or more but 10% by mass or less, in terms of enhancement of image density, fixability, and discharging stability.

To obtain the ink, the pigment is dispersed by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group and carboxyl group to the pigment (e.g., carbon) to disperse the pigment in water.

To coat the surface of the pigment with resin, the pigment is encapsulated by microcapsules to make the pigment dispersible in water. This can be referred to as a resin-coated pigment. In this case, the pigment to be added to ink is not necessarily coated with resin. Pigments partially or wholly uncovered with resin may be dispersed in the ink unless the pigments have an adverse impact.

To use a dispersant, for example, a known dispersant of a small molecular weight type or a high molecular weight type represented by a surfactant is used to disperse the pigments in ink. As the dispersant, it is possible to use, for example, anionic surfactants, cationic surfactants, amphoteric surfactants, nonionic surfactants, etc. depending on the pigments.

Also, a nonionic surfactant (RT-100, manufactured by TAKEMOTO OIL & FAT CO., LTD.) and a formalin condensate of naphthalene sodium sulfonate are suitable as dispersants. These dispersants can be used alone or in combination.

### Pigment Dispersion

The ink can be obtained by mixing a pigment with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by mixing and dispersing water, pigment, pigment dispersant, and other optional components and adjusting the particle size. It is good to use a dispersing device for dispersion.

The particle diameter of the pigment in the pigment dispersion has no particular limit. For example, the maximum frequency in the maximum number conversion is preferably 20 nm or more but 500 nm or less and more preferably 20 or more but 150 nm or less to improve dispersion stability of the pigment and ameliorate the discharging stability and image quality such as image density. The particle diameter of the pigment can be measured using a particle size analyzer (NANOTRAC WAVE-UT151, manufactured by MicrotracBEL Corp).

In addition, the proportion of the pigment in the pigment dispersion is not particularly limited and can be suitably selected to suit a particular application. In terms of improving discharging stability and image density, the content is preferably 0.1% by mass or more but 50% by mass or less, more preferably 0.1% by mass or more but 30% by mass or less. During the production, coarse particles are optionally filtered off with a filter, a centrifuge, etc. preferably followed by degassing.

### Resin

Regarding the type of the resin used for the color ink, the resins similar to those for the clear ink can be used. Of these, for the color ink, a urethane resin or an acrylic resin is preferable.

Regarding the organic solvent and the other components in the color ink, the organic solvent and the other components similar to those for the clear ink can be used.

The maximum tensile stress of a dry film of the color ink is preferably 1.2 N/mm² or more, more preferably 2 N/mm² or more, and further preferably 5 N/mm² or more.

When the maximum tensile stress of the dry film of the color ink is 1.2 N/mm² or more, a printed matter excellent in scratch resistance can be obtained.

The maximum tensile stress of the dry film of the color ink can be measured in the same manner as in the maximum tensile stress of the dry film of the clear ink.

### Printing Target

The printing target is not particularly limited and may be appropriately selected depending on the intended purpose. The print medium that is usable is, for example, plain paper, gloss paper, special paper, or cloth. In the present disclosure, however, it is possible to form a favorable image even on a leather, among others.

The leather is not particularly limited and examples of the leather that is usable include, but are not limited to, permeable natural leathers such as a tanned leather, natural leathers lacquer-treated with (provided with a top coat layer of), for example, an acrylic resin, a urethane resin, or vinyl chloride, artificial leathers, synthetic leathers, recycled leathers, and leather products.

Examples of the leather include, but are not limited to, natural leathers, artificial leathers, synthetic leathers, recycled leathers, surface-treated natural leathers, surface-treated artificial leathers, surface-treated synthetic leathers, and surface-treated recycled leathers.

Examples of the surface treatment include, but are not limited to, surface treatments using, for example, a resin or oil.

Examples of the resin include, but are not limited to, an acrylic resin, a urethane resin, and a vinyl chloride resin.

The natural leather is not particularly limited and examples of the natural leather that is usable include, but are not limited to, leathers made from skins of various animals, such as a cow leather, a pig leather, a sheep leather, and a horse leather.

The artificial leather is not particularly limited and examples of the artificial leather that is usable include, but are not limited to, base materials obtained by impregnating, with a synthetic resin, nonwoven fabric made of, for example, microfibers of nylon, polyester, etc. and those base materials that are further surface-coated with a synthetic resin.

The synthetic leather is not particularly limited and examples of the synthetic leather that is usable include, but are not limited to, those obtained by coating a synthetic resin onto the surfaces of base materials of woven and knitted fabric made of, for example, natural fibers, nylon fibers, or polyester fibers.

By virtue of their unique soft texture and sense of luxury, leather products made from the above leathers are used for a wide variety of fields such as clothing, bags, shoes, interior materials, and vehicle interior materials.

### First Clear Ink Applying Step and Clear Ink Applying Unit

The first clear ink applying step is a step of applying the clear ink to a region of the leather where the color ink is to be applied. The first clear ink applying step is performed by the clear ink applying unit.

The clear ink used in the first clear ink applying step is the clear ink used in the above-described printing method and printing device of the present disclosure.

### Color Ink Applying Step and Color Ink Applying Unit

The color ink applying step is a step of applying the color ink onto the first clear ink applied. The color ink applying step is performed by the color ink applying unit.

The color ink used in the color ink applying step is the color ink used in the above-described printing method and printing device of the present disclosure.

### Second Clear Ink Applying Step and Clear Ink Applying Unit

The second clear ink applying step is a step of applying the clear ink onto the color ink applied. The second clear ink applying step is performed by the clear ink applying unit.

The clear ink used in the second clear ink applying step is the clear ink used in the above-described printing method and printing device of the present disclosure.

How to apply the clear ink and the color ink is not particularly limited and may be appropriately selected depending on the intended purpose. Specific examples of such methods, but are not limited to, inkjet methods, blade coating methods, gravure coating methods, bar coating methods, roll coating methods, dip coating methods, curtain coating methods, slide coating methods, die coating methods, and spray coating methods. Of these, inkjet methods are preferable.

The color ink applying step of applying the color ink and the first and second clear ink applying steps of applying the clear ink may be performed by the same ink applying unit or may be performed by separate ink applying units. In forming the clear ink film on the color ink film (color image), in terms of scratch resistance of a printed matter, the rate of the clear ink to be printed is preferably 20% or more but 80% or less and more preferably 40% or more but 80% or less. A print pattern of the clear ink is not particularly limited and may be appropriately selected depending on the intended purpose. Examples of the print pattern include, but are not limited to, a halftone image and a solid image.

### Other Steps and Other Units

Examples of the other steps include, but are not limited to, a drying step of drying the leather after the second clear ink applying step. The drying step is performed by a drying unit.

A heating temperature in the drying step is preferably 40° C. or higher but 120° C. or lower. In terms of scratch resistance and fixability, the heating temperature is more preferably 60° C. or higher but 120° C. or lower. In terms of avoiding loss of flexibility of the leather, the heating temperature is further preferably 60° C. or higher but 90° C. or lower.

In the present disclosure, a ratio (A-B)/A, where A represents bending resistance of the leather before printing and B represents bending resistance of the leather after printing, is preferably 40% or less and more preferably 25% or less.

The ratio (A-B)/A of 40% or less means that an image can be formed on a leather without loss of the intrinsic softness of the leather.

The bending resistance of the leather can be measured in the following manner, for example.

### Bending Resistance

The leather is cut out with a cutter into a section having a size of 150 mm×25 mm. The section is placed on a Handle-O-Meter (model HOM-200, available from DAIEI KAGAKU SEIKI MFG. Co., Ltd.). The bending resistance of the leather can be measured under the following conditions.

### Measurement Conditions

Slit width: 2 cm
Position at which a blade is to be indented: 5 cm from one end of the longer side
Value to be measured: value of the maximum load

### Printed Matter

The printed matter of the present disclosure is a printed matter including a leather, a first clear ink film on the leather, a color ink film on the first clear ink film, and a second clear ink film on the color ink film. A ratio (A-B)/A, where A represents bending resistance of the leather before printing and B represents bending resistance of the leather after printing, is 40% or less and preferably 25% or less.

The bending resistance of the leather can be measured in the same manner as described above. Even when a leather is used as the printing target, the printed matter of the present disclosure is excellent in fixability and scratch resistance and does not involve degradation in textures such as comfortable touch feelings of the leather.

### Printing Device and Printing Method

The ink of the present disclosure can be suitably applied to various printing devices employing an inkjet printing method such as printers, facsimile machines, photocopiers, multifunction peripherals (serving as a printer, a facsimile machine, and a photocopier), and 3D model manufacturing devices.

In the present disclosure, the printing device and the printing method represent a device capable of discharging ink, various processing liquids, etc. to a printing target (a print medium) and a method printing an image on the print medium using the device. The print medium means an article to which the ink or the various processing fluids can be attached at least temporarily.

The printing device may further optionally include a device to attach pre-coating liquid and a device relating to feeding, transferring, and ejecting the print medium and other devices referred to as a pre-processing device, a post-processing device, etc. in addition to the head portion to discharge the ink.

The printing device and the printing method may further optionally include a heater for use in the heating process and a drier for use in the drying process. For example, the heating device and the drying device heat and dry the top surface and the bottom surface of a print medium having an image. The heating device and the drying device are not particularly limited. For example, a fan heater and an infra-red heater can be used. The print medium can be heated and dried before, during, and after printing.

In addition, the printing device and the printing method are not limited to those producing merely meaningful visible images such as texts and figures with the ink. For example, the printing device and the printing method can produce patterns like geometric design and 3D images.

In addition, the printing device includes both a serial type device in which the liquid discharging head is caused to move and a line type device in which the liquid discharging head is not moved, unless otherwise specified.

Furthermore, in addition to the desktop type, this printing device includes a wide type capable of printing images on a large print medium such as A0, a continuous printer capable of using continuous paper wound up in a roll form as print media.

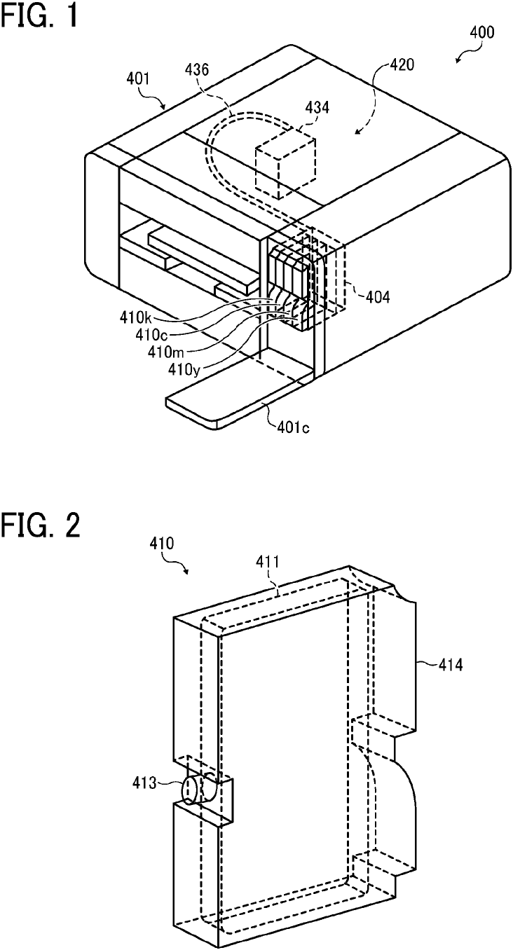

The printing device of the present disclosure is described using an example with reference to FIG. 1 and FIG. 2. FIG. 1 is a perspective view illustrating the image printing device. FIG. 2 is a perspective view illustrating the main tank. An image forming apparatus 400 as an example of the printing device is a serial type image forming apparatus. A mechanical unit 420 is disposed in an exterior 401 of the image forming apparatus 400. Each ink accommodating unit (ink container) 411 of each main tank 410 (410k, 410c, 410m, and 410y) for each color of black (K), cyan (C), magenta (M), and yellow (Y) is made of a packing member such as aluminum laminate film. The ink container 411 is accommodated in a plastic housing unit 414. As a result, the main tank 410 is used as an ink cartridge of each color. The main tank can also be provided for the clear ink.

A cartridge holder 404 is disposed on the rear side of the opening when a cover 401c is opened. The cartridge holder 404 is detachably attached to the main tank 410. As a result, each ink discharging outlet 413 of the main tank 410 is communicated with a discharging head 434 for each color via a supplying tube 436 for each color so that the ink can be discharged from the discharging head 434 to a printing target.

Moreover, image forming, recording, printing, etc. in the present disclosure represent the same meaning.

A print medium, media, and a printing target represent the same meaning.

### EXAMPLES

The present disclosure will be described below by way of Examples. The present disclosure should not be construed as being limited to these Examples.

### Preparation Example 1 of Pigment Dispersion Liquid

### Preparation of Black Pigment Dispersion Liquid A

The following materials were premixed and then dispersed under circulation for 7 hours in a disc-type bead mill (obtained from Shinmaru Enterprises Corporation, KDL model, media: zirconia balls 0.3 mm in diameter) to obtain black pigment dispersion liquid A.

### Composition

Carbon black pigment (product name: Monarch800, obtained from Cabot Corporation): 15 parts by mass
Anionic surfactant (PIONIN A-51-B, obtained from TAKEMOTO OIL & FAT Co., Ltd.): 2 parts by mass
Ion-exchanged water: 83 parts by mass

### Preparation Example 2 of Pigment Dispersion Liquid

### Preparation of Cyan Pigment Dispersion Liquid A

Cyan pigment dispersion liquid A was obtained in the same manner as in Preparation Example 1 of Pigment Dispersion Liquid except that the carbon black pigment was changed to Pigment Blue 15:3 (product name: LIONOL BLUE FG-7351, obtained from TOYO INK CO., LTD.).

### Preparation Example 3 of Pigment Dispersion Liquid

### Preparation of Black Pigment Dispersion Liquid B

11.2 g of styrene, 2.8 g of acrylic acid, 12 g of lauryl methacrylate, 4 g of polyethylene glycol methacrylate, 4 g of styrene macromer, and 0.4 g of mercaptoethanol were mixed together in a flask, and the mixture was heated to 65° C.

Separately, 100.8 g of styrene, 25.2 g of acrylic acid, 108 g of lauryl methacrylate, 36 g of polyethylene glycol methacrylate, 60 g of hydroxylethyl methacrylate, 36 g of styrene macromer, 3.6 g of mercaptoethanol, 2.4 g of azobismethylvaleronitrile, and 18 g of methyl ethyl ketone were mixed together. The mixed solution was added dropwise to the flask for 2.5 hours.

After the addition, a mixed solution of 0.8 g of azobismethylvaleronitrile and 18 g of methyl ethyl ketone was added dropwise to the flask for 0.5 hours.

After aging at 65° C. for 1 hour, 0.8 g of azobismethylvaleronitrile was added, followed by aging for another 1 hour.

After completion of reaction, 364 g of methyl ethyl ketone was added to the flask to obtain 800 g of polymer solution A having a solid portion concentration of 50% by mass.

28 g of the polymer solution A, 42 g of carbon black (obtained from Cabot Corporation, Black Pearls 1000), 13.6 g of a 1 mol/L aqueous potassium hydroxide solution, 20 g of methyl ethyl ketone, and 13.6 g of water were stirred thoroughly and kneaded in a roll mill. The obtained paste was charged into 200 g of pure water, and the methyl ethyl ketone was removed with an evaporator. After pressure filtration with a polyvinylidene fluoride membrane filter having an average pore diameter of 5 micrometers, the amount of water was adjusted so that the solid portion concentration would be 20% by mass, to obtain styrene-acrylic-based resin-coated black pigment dispersion liquid B having a solid portion concentration of 20% by mass.

### Preparation Example 4 of Pigment Dispersion Liquid

### Preparation of Cyan Pigment Dispersion Liquid B

Styrene-acrylic-based resin-coated cyan pigment dispersion liquid B having a solid portion concentration of 20% by mass was obtained in the same manner as in Preparation Example 3 of Pigment Dispersion Liquid except that the carbon black was changed to Pigment Blue 15:4 (obtained from SENSIENT TECHNOLOGIES CORPORATION, SMART Cyan 3154BA).

### Preparation Example 1 of Polyurethane Resin Emulsion

### Preparation of Polyester-Based Urethane Resin Emulsion

In a nitrogen purge vessel equipped with a thermometer, a nitrogen gas introducing tube, and a stirrer, 200.4 g of a two-fold amount of polyesterpolyol (product name: POLYLITE OD-X-2251, obtained from DIC Corporation, average molecular weight: 2,000), 15.7 g of 2,2-dimethylolpropionic acid, 48.0 g of isophorone diisocyanate, and 77.1 g of methyl ethyl ketone serving as an organic solvent were allowed to react using 0.06 g of dibutyltin dilaurate (DMTDL) as a catalyst. After the reaction was allowed to continue for 4 hours, 30.7 g of methyl ethyl ketone serving as a dilution solvent was added, and the reaction was allowed to further continue. At the time the average molecular weight of the reaction product reached a value in the range of from 20,000 through 60,000, 1.4 g of methanol was charged to terminate the reaction, to obtain an organic solvent solution of a urethane resin. 13.4 g of a 48 % by mass aqueous potassium hydroxide solution was added to the organic solvent solution of the urethane resin to neutralize the carboxyl group of the urethane resin.

715.3 g of water was added and the mixture was thoroughly stirred, followed by aging and removal of the solvent, to obtain a polyester-based urethane resin emulsion having a solid portion concentration of 30% by mass. The polyester-based urethane resin emulsion was measured for minimum film forming temperature (MFT) using “minimum film forming temperature tester” (obtained from Imoto Machinery Co., Ltd.). The measured minimum film forming temperature was 74° C.

### Production Example 1 of Color Ink

### Production of Color Ink A

The following ink materials were provided in the following amounts so that the total amount would be 100 parts by mass by the addition of ion-exchanged water, followed by mixing and stirring. The mixture was filtrated through a filter having an average pore diameter of 5 micrometers (obtained from Sartorius AG, MINISART) to prepare color ink A.

### Ink Materials and Amounts Thereof

The above black pigment dispersion liquid B: 20 parts by mass
The above polyester-based urethane resin emulsion of Preparation Example 1: 6.0 parts by mass
Triton HW1000 (obtained from The Dow Chemical Company): 1.0 part by mass
BYK348 (obtained from BYK Chemie K.K., silicone surfactant): 0.2 parts by mass
1,2-Propanediol (product name: propylene glycol, obtained from ADEKA CORPORATION): 9 parts by mass
1,3-Propanediol (obtained from DuPont de Nemours, Inc.): 1 part by mass
3-Methyl-1,5-pentanediol (product name: MPD, obtained from KURARAY Co., Ltd.): 2 parts by mass
3-Methoxy-3-methyl-1-butanol (product name: SOLFIT, obtained from KURARAY Co., Ltd.): 3 parts by mass
3-Methoxy-N,N-dimethylpropionamide (product name: EQUAMIDE M100, obtained from Idemitsu Kosan Co., Ltd.): 10 parts by mass
PROXEL LV (obtained from Avecia Inc., preservative and fungicide): 0.1 parts by mass
Ion-exchanged water: balance (total: 100 parts by mass)

### Production Examples 2 to 5 of Color Inks

### Production of Color Inks B to E

Color inks B to E were produced in the same manner as in Production Example 1 of Color Ink except that the ink materials and amounts thereof were changed to those described in Table 1. The amount of the resin in Table 1 is the amount of the solid portion thereof.

The maximum tensile stress of a dry film of each of the obtained color inks was measured in the following manner. Results are given in Table 1.

### Maximum Tensile Stress of Dry Film of Color Ink

8 g of each of the color inks was placed in a TEFLON (registered trademark) Petri dish having a diameter of 50 mm. The color ink was dried for 2 days in a hot air circulation-type thermostat chamber of 70° C. to obtain a dry film of the color ink. The obtained dry film of each color ink was cut out with a cutter into a section having a size of 5 mm×50 mm. The section was subjected to a tensile test under the following measurement conditions to measure the maximum tensile stress. The average thickness of the dry film of the color ink was an average value of measurements obtained at three or more points with a micrometer, and was from 0.3 mm through 0.8 mm.

### Measurement Conditions of Tensile Stress

Device: Autograph AG-10N obtained from Shimadzu Corporation
Load cell: 50 N
Tensile speed: 150 mm/min
Distance between chucks: 4 mm
Sample width: 5 mm

### Production Examples 1 to 8 of Clear Ink

### Production of Clear Inks A to H

Clear inks A to H were produced in the same manner as in Production Example 1 of Color Ink except that the ink materials and amounts thereof were changed to those for clear inks described in Table 2 and Table 3. The amount of the resin in Table 2 and Table 3 is the amount of the solid portion thereof.

The maximum tensile stress of a dry film of each of the obtained clear inks was measured in the same manner as in the maximum tensile stress of the dry film of the color ink. Results are given in Table 2 and Table 3.

TABLE 1

| | | Color Ink No. | | | | |
|---|---|---|---|---|---|---|
| | | A | B | C | D | E |
| Coloring material | Black pigment dispersion liquid A | | | 20 | | |
| | Black pigment dispersion liquid B (resin-coated type) | 20 | | | | 20 |
| | Cyan pigment dispersion liquid A | | | | 20 | |
| | Cyan pigment dispersion liquid B (resin-coated type) | | 20 | | | |
| Resin | Polyurethane resin SUPERFLEX 300 | | | | | |
| | Polyurethane resin of Preparation Example 1 (MFT:74° C.) | 6.0 | | | | |
| | Polyurethane resin W6110 | | | 4.5 | | |
| | Acrylic resin MOVINYL 6800 | | | | | |
| | Acrylic resin MOVINYL 6810 | | | | | |
| | Acrylic resin MOVINYL 6899D | | | | | |
| | Acrylic resin MOVINYL 6750 | | 7.0 | | | |
| | Fluororesin AF1600 | | | | 10.0 | |
| Surfactant | Surfactant Triton HW1000 | 1.0 | 1.0 | 1.0 | 1.0 | 1.0 |
| | Surfactant BYK348 | 0.2 | 0.4 | 0.2 | 0.5 | 0.3 |
| Organic solvent | 1,2-Propanediol | 9 | 5 | | | 8 |
| | 1,3-Propanediol | 1 | | 8 | 3 | |
| | 1,3-Butanediol | | 5 | | 5 | |
| | 2-Ethyl-1,3-hexanediol | | | 5 | | |
| | 3-Methyl-1,5-penianediol | 2 | | | 2 | 2 |
| | 3-Methoxy-1-butanol | | | 2 | 2 | 5 |
| | 3-Methoxy-3-methyl-1-butanol | 3 | 5 | | | |
| | EQUAMlDE M100 3-Methoxy-N,N-dimethylpropionamide | 10 | 8 | 5 | | 3 |
| | 3-Butoxy-N,N-dimethylproionamide | | 2 | 5 | 8 | 7 |
| Preservative | PROXEL LV (obtained from Avecia Inc.) | 0.1 | 0.1 | 0.1 | 0.1 | 0.1 |
| Water | Highly pure water | Balance | Balance | Balance | Balance | Balance |
| Total (% by mass) | | 100 | 100 | 100 | 100 | 100 |
| Maximum tensile stress of dry film (N/mm²) | | 5.3 | 8.7 | 2.1 | 1.4 | 0.9 |

TABLE 2

| | | Clear Ink No. | | | | | |
|---|---|---|---|---|---|---|---|
| | | A | B | C | D | E | F |
| Resin | Polyurethane resin SUPERFLEX 300 | | 2.5 | 3.0 | | | 4.0 |
| | Polyurethane resin of Preparation Example 1 (MFT:74° C.) | | | | 5.0 | | |
| | Polyurethane resin W6110 | 3.0 | | | | 2.0 | |
| | Acrylic resin MOVINYL 6800 | | 3.0 | | | | |
| | Acrylic resin MOVINYL 6810 | 5.0 | | | | 8.0 | |
| | Acrylic resin MOVINYL 6899D | | | 4.0 | | | |
| | Acrylic resin MOVINYL 6750 | | | | 2.0 | | |
| | Fluororesin AF1600 | | | | | | |
| Surfactant | Surfactant Triton HW 1000 | 1.0 | 1.0 | 1.0 | 1.0 | 1.0 | 1.0 |
| | Surfactant BYK348 | 0.2 | 0.2 | 0.2 | 0.2 | 0.2 | 0.2 |
| Organic solvent | 1,2-Propanediol | 10 | | 5 | 3 | | 4 |
| | 1,3-Propanediol | | 2 | 5 | 7 | 11 | |
| | 1,3-Butanediol | 2 | 8 | | | | 8 |
| | 2-Ethyl-1,3-hexanediol | | 5 | | 4 | | 2 |
| | 3-Methyl-1,5-pentanediol | | | 3 | | 4 | |
| | 3-Methoxy-1-butanol | | 3 | | 4 | 4 | 5 |
| | 3-Methoxy-3-methyl-1-butanol | 5 | | 5 | 4 | 3 | 1 |
| | EQUAMIDE M100 3-Methoxy-N,N-dimethylpropionamide | 10 | 5 | 7 | | | |
| | 3-Butoxy-N,N-dimethylproionamide | | 5 | 3 | | | 8 |
| Preservative | PROXEL LV (obtained from Avecia Inc.) | 0.1 | 0.1 | 0.1 | 0.1 | 0.1 | 0.1 |
| Water | Highly pure water | Balance | Balance | Balance | Balance | Balance | Balance |
| Total (% by mass) | | 100 | 100 | 100 | 100 | 100 | 100 |
| Maximum tensile stress of dry film (N/mm²) | | 11.2 | 6.2 | 7.1 | 3.8 | 10.5 | 1.1 |

TABLE 3

| | | Clear Ink No. | |
|---|---|---|---|
| | | G | H |
| Resin | Polyurethane resin SUPERFLEX 300 | | |
| | Polyurethane resin of Preparation Example 1 (MFT:74° C.) | | |
| | Polyurethane resin W6110 | | |
| | Acrylic resin MOVINYL 6800 | | |
| | Acrylic resin MOVINYL 6810 | | |
| | Acrylic resin MOVINYL 6899D | | |
| | Acrylic resin MOVINYL 6750 | 7.0 | |
| | Fluororesin AF1600 | | 6.0 |
| Surfactant | Surfactant Triton HW1000 | 1.0 | 1.0 |
| | Surfactant BYK348 | 0.2 | 0.2 |
| Organic solvent | 1,2-Propanediol | | 2 |
| | 1,3-Propanediol | 5 | 6 |
| | 1,3-Butanediol | 5 | |
| | 2-Ethyl-1,3-hexanediol | 2 | 5 |
| | 3-Methyl-1,5-pentanediol | | |
| | 3-Methoxy-1-butanol | | |
| | 3-Methoxy-3-methyl-1-butanol | 6 | 5 |
| | EQUAMIDE M100 3-Methoxy-N,N-dimethylpropionamide | 4 | 6 |
| | 3-Butoxy-N,N-dimethylproionamide | 4 | |
| Preservative | PROXEL LV (obtained from Avecia Inc.) | 0.1 | 0.1 |
| Water | Highly pure water | Balance | Balance |
| Total (% by mass) | | 100 | 100 |
| Maximum tensile stress of dry film (N/mm²) | | 2.9 | 1.2 |

In Table 1 to Table 3, details of each of the components are as follows.
Resin
MOVINYL 6810 (obtained from Japan Coating Resin Co., Ltd., acrylic resin, solid portion concentration: 42% by mass, glass transition temperature Tg=100° C.)
MOVINYL 6800 (obtained from Japan Coating Resin Co., Ltd., acrylic resin, solid portion concentration: 45% by mass, glass transition temperature Tg=80° C.)
MOVINYL 6899D (obtained from Japan Coating Resin Co., Ltd., acrylic resin, solid portion concentration: 46% by mass, glass transition temperature Tg=49° C.)
MOVINYL 6750 (obtained from Japan Coating Resin Co., Ltd., acrylic resin, solid portion concentration: 50% by mass, glass transition temperature Tg=0° C.)
AF1600 (obtained from Chemours-Mitsui Fluoroproducts Co., Ltd., fluororesin)
SUPERFLEX 300 (obtained from DKS Co. Ltd., polyurethane resin, solid portion concentration: 30% by mass)
W6110 (polyurethane resin, obtained from Mitsui Chemicals, Inc., solid portion concentration: 35% by mass)

Organic solvent
1,3-Butanediol (product name: 1,3-butanediol, obtained from DAICEL CORPORATION)
2-Ethyl-1,3-hexanediol (product name: octanediol, obtained from KH Neochem Co., Ltd.)
3-Methoxy-1-butanol (product name: MB, obtained from DAICEL CORPORATION)
3-Butoxy-N,N-dimethylpropionamide (product name: EQUAMIDE B100, obtained from Idemitsu Kosan Co., Ltd.)

Surfactant
Triton HW1000 (obtained from The Dow Chemical Company)
BYK348 (obtained from BYK Chemie K.K., silicone surfactant)

Preservatives and Fungicides
PROXEL LV, obtained from Avecia Inc.

### Examples 1 to 8 and Comparative Examples 1 to 8

### Preparation of Ink Set

According to the combinations of the color ink and the clear ink in Table 4 to Table 7, ink sets of Examples 1 to 8 and Comparative Examples 1 to 8 were prepared.

### Image Formation

In Examples 1 to 8 and Comparative Examples 3 to 7, the color ink and the clear ink of each of the ink sets were charged respectively to the black section and the magenta section of an inkjet printer (device name: Ri100, obtained from Ricoh Company, Limited). The following natural leather and synthetic leather as printing targets were printed in a T-shirt Fast Mode with a clear (magenta) solid image of 80% gradation, then with a color solid image of 100% gradation, and then with a clear (magenta) solid image of 50% gradation. The printed matters were allowed to pass through a drying unit using hot air of 70° C. for drying and fixing.

In Comparative Examples 1 and 2, the following natural leather and synthetic leather as printing targets were printed in a T-shirt Fast Mode with a color solid image of 100% gradation and then with a clear (magenta) solid image of 60% gradation. The printed matters were allowed to pass through a drying unit using hot air of 70° C. for drying and fixing.

In Comparative Example 8, the following natural leather and synthetic leather as printing targets were printed in a T-shirt Fast Mode with a clear (magenta) solid image of 80% gradation and then with a color solid image of 100% gradation. The printed matters were allowed to pass through a drying unit using hot air of 70° C. for drying and fixing.

Printing targets
   (1) Natural leather (surface-treated with an acrylic resin, cow leather, average thickness: 2 mm)
   (2) Synthetic leather (surface-treated with a urethane resin, average thickness: 1.2 mm)

Each of the obtained images was measured for “difference in bending resistance” and evaluated for “scratch resistance” and “fixability” in the following manners. Results are given in Table 4 to Table 7.

### Difference in Bending Resistance

Each of the leather before printing and the leather after printing was cut out with a cutter into a section having a size of 150 mm×25 mm. The section was placed on a Handle-O-Meter (model HOM-200, obtained from DAIEI KAGAKU SEIKI MFG. Co., Ltd.). The bending resistance of the leather was measured under the following conditions to determine the ratio (A-B)/A, where A represents bending resistance of the leather before printing and B represents bending resistance of the leather after printing.

### Measurement Conditions

Slit width: 2 cm
Position at which a blade was to be indented: 5 cm from one end of the longer side
Value to be measured: value of the maximum load

### Evaluation of Scratch Resistance

Each of the obtained images was cut out into a section having a size of 2.5 cm×20 cm. The section was placed in a rubbing color fastness tester (model: AR-2, obtained from INTEC CO., LTD.). At a load of 500 g, dry white cloth (Kanakin No. 3) was reciprocated thereon 100 times at a reciprocation speed of 30 times/min. The ink coating and the state of the white cloth were observed and evaluated according to the following criteria. Ranks AA, A, and B are practically usable levels.

### Evaluation Criteria

AA: The leather serving as a base material was not exposed, and almost no color bleeding onto the white cloth was observed.

A: The leather serving as a base material was not exposed, and slight color bleeding onto the white cloth was observed.

B: The leather serving as a base material was partially exposed, and color bleeding onto part of the white cloth.

C: The leather serving as a base material was partially exposed, and color bleeding onto the entire white cloth was observed.

D: Half or more of the leather serving as a base material was exposed.

### Evaluation of Fixability

The solid portion of each of the obtained images was subjected to a cross-cut test using cloth adhesive tape (obtained from NICHIBAN Co., Ltd., 123LW-50). The number of the remaining grids out of 100 test grids was counted and evaluated according to the following criteria. Ranks AA, A, and B are practically usable levels.

### Evaluation Criteria

AA: The number of the remaining grids was 100.

A: The number of the remaining grids was 90 or more but less than 100.

B: The number of the remaining grids was 80 or more but less than 90.

C: The number of the remaining grids was 70 or more but less than 80.

D: The number of the remaining grids was less than 70.

TABLE 4

| | | | | | | |
|---|---|---|---|---|---|---|
| | | Ex. 1 | Ex. 2 | Ex. 3 | Ex. 4 | Ex. 5 |
| Ink set | Color ink No. | A | B | C | B | D |
| | Clear ink No. | A | B | B | C A | |
| Order of application of inks | First clear ink | 1 | 1 | 1 | 1 | 1 |
| | Color ink | 2 | 2 | 2 | 2 | 2 |
| | Second clear ink | 3 | 3 | 3 | 3 | 3 |
| Difference in bending resistance | Natural leather | 15% | 23% | 7% | 19% | 37% |
| | Synthetic leather | 13% | 26% | 7% | 23% | 38% |
| Scratch resistance | Natural leather | AA | A | A | B | A |
| | Synthetic leather | AA | A | AA | A | A |
| Fixability | Natural leather | AA | AA | A | AA | A |
| | Synthetic leather | AA | AA | AA | AA | A |

TABLE 5

| | | | | |
|---|---|---|---|---|
| | | Ex. 6 | Ex. 7 | Ex. 8 |
| Ink set | Color ink No. | C | C | A |
| | Clear ink No. | D | E | D |
| Order of application of inks | First clear ink | 1 | 1 | 1 |
| | Color ink | 2 | 2 | 2 |
| | Second clear ink | 3 | 3 | 3 |
| Difference in bending resistance | Natural leather | 24% | 53% | 3% |
| | Synthetic leather | 24% | 51% | 5% |
| Scratch resistance | Natural leather | B | A | B |
| | Synthetic leather | B | A | B |
| Fixability | Natural leather | A | A | B |
| | Synthetic leather | A | A | B |

TABLE 6

| | | | | | | |
|---|---|---|---|---|---|---|
| | | Comp. Ex. 1 | Comp. Ex. 2 | Comp. Ex. 3 | Comp. Ex. 4 | Comp. Ex. 5 |
| Ink set | Color ink No. | B | D | D | E | C |
| | Clear ink No. | C | E | F | F | - |
| Order of application of inks | First clear ink | - | - | 1 | 1 | - |
| | Color ink | 1 | 1 | 2 | 2 | 1 |
| | Second clear ink | 2 | 2 | 3 | 3 | - |
| Difference in bending resistance | Natural leather | 13% | 61% | 25% | 2% | 4% |
| | Synthetic leather | 16% | 57% | 21% | 4% | 6% |
| Scratch resistance | Natural leather | C | D | D | D | D |
| | Synthetic leather | B | D | D | D | D |
| Fixability | Natural leather | D | C | C | D | D |
| | Synthetic leather | D | B | C | D | C |

TABLE 7

| | | | | |
|---|---|---|---|---|
| | | Comp. Ex. 6 | Comp. Ex. 7 | Comp. Ex. 8 |
| Ink set | Color ink No. | D | C | B |
| | Clear ink No. | G | H | C |
| Order of application of inks | First clear ink | 1 | 1 | 1 |
| | Color ink | 2 | 2 | 2 |
| | Second clear ink | 3 | 3 | - |
| Difference in bending resistance | Natural leather | 49% | 33% | 21%, |
| | Synthetic leather | 54% | 37% | 22% |
| Scratch resistance | Natural leather | D | D | D |
| | Synthetic leather | D | C | D |
| Fixability | Natural leather | B | D | A |
| | Synthetic leather | D | C | A |

Aspects of the present disclosure are as follows, for example.

<1> A printing method for printing an image on a leather with an ink set including a color ink and a clear ink, the printing method including:
applying the clear ink to a region of the leather where the color ink is to be applied;
applying the color ink onto the clear ink applied; and
applying the clear ink onto the color ink applied,
wherein the color ink includes a coloring material, an organic solvent, and a resin and the clear ink includes an organic solvent, an acrylic resin, and a urethane resin.

<2> The printing method according to < 1> above, wherein the clear ink includes an amide compound represented by General Formula (1) below:

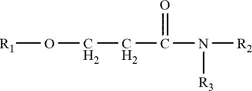

where R₁, R₂, and R₃ each independently represent a hydrocarbon group having one or more but eight or less carbon atoms.

<3> The printing method according to <1> or <2> above, wherein the resin in the color ink includes a urethane resin or an acrylic resin, or both.

<4> The printing method according to any one of <1> to <3> above, wherein the acrylic resin in the clear ink has a glass transition temperature of 50° C. or higher.

<5> The printing method according to any one of <1> to <4> above, wherein the coloring material in the color ink includes a resin-coated pigment.

<6> The printing method according to any one of <1> to <5> above, wherein the leather is at least one selected from the group consisting of natural leathers, artificial leathers, synthetic leathers, recycled leathers, surface-treated natural leathers, surface-treated artificial leathers, surface-treated synthetic leathers, and surface-treated recycled leathers.

<7> The printing method according to any one of <1> to <6> above, wherein a ratio (A-B)/A, where A represents bending resistance of the leather before printing and B represents bending resistance of the leather after printing, is 40% or less.

<8> The printing method according to any one of <1> to <7> above, further including drying the leather after the applying the clear ink onto the color ink applied.

<9> The printing method according to any one of <1> to <8> above, wherein a maximum tensile stress of a dry film of the color ink is 1.2 N/mm² or more and a maximum tensile stress of a dry film of the clear ink is 3.5 N/mm² or more.

<10> A printing device for printing an image on a leather with an ink set including a color ink and a clear ink, the printing device including:
a color ink applying unit configured to apply the color ink; and
a clear ink applying unit configured to apply the clear ink,
wherein the color ink includes a coloring material, an organic solvent, and a resin and the clear ink includes an organic solvent, an acrylic resin, and a urethane resin.

<11> The printing device according to <10> above, wherein a maximum tensile stress of a dry film of the color ink is 1.2 N/mm² or more and a maximum tensile stress of a dry film of the clear ink is 3.5 N/mm² or more.

< 12> An ink set for printing an image on a leather as a printing target, the ink set including:
a color ink including a coloring material, an organic solvent, and a resin; and
a clear ink including an organic solvent, an acrylic resin, and a urethane resin.

<13> The ink set according to <12> above, wherein a maximum tensile stress of a dry film of the color ink is 1.2 N/mm² or more and a maximum tensile stress of a dry film of the clear ink is 3.5 N/mm² or more.

< 14> A printed matter including:
a leather;
a first clear ink film on the leather;
a color ink film on the first clear ink film; and
a second clear ink film on the color ink film,
wherein a ratio (A-B)/A, where A represents bending resistance of the leather before printing and B represents bending resistance of the leather after printing, is 40% or less.

The printing method according to any one of <1> to <9> above, the printing device according to <10> or <11> above, the ink set according to <12> or <13> above, and the printed matter according to <14> above can solve the problems in the art and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Tis patent application is based on and claims priority to Japanese Patent Application No. 2020-125094, filed on Jul. 22, 2020 and Japanese Patent Application No. 2021-065240, filed on Apr. 7, 2021, in the Japan Patent Office, the entire disclosure of each of which is hereby incorporated by reference herein.

### Reference Signs List

400 Image forming apparatus
401 Exterior of image forming apparatus
401c Cover of image forming apparatus
404 Cartridge holder
410 Main tank
410k, 410c, 410m, 410y Main tank for each color of black (K), cyan (C), magenta (M), and yellow (Y)
411 Ink container
413 Ink discharging outlet
414 Plastic housing unit
420 Mechanical unit
434 Discharging head
436 Supplying tube

1. A printing method for printing an image on a leather with an ink set comprising a color ink and a clear ink, the printing method comprising:
applying the clear ink to a region of the leather where the color ink is to be applied;
applying the color ink onto the clear ink applied; and
applying the clear ink onto the color ink applied,
wherein the color ink comprises a coloring material, an organic solvent, and a resin and the clear ink comprises an organic solvent, an acrylic resin, and a urethane resin.

2. The printing method according to claim 1, wherein the clear ink comprises an amide compound represented by General Formula (1) below: 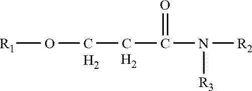
where R1, R₂, and R₃ each independently represent a hydrocarbon group having one or more but eight or less carbon atoms.

3. The printing method according to claim 1 wherein the resin in the color ink comprises a urethane resin or an acrylic resin, or both.

4. The printing method according to claim 1, wherein the acrylic resin in the clear ink has a glass transition temperature of 50° C. or higher.

5. The printing method according to claim 1, wherein the coloring material in the color ink comprises a resin-coated pigment.

6. The printing method according to claim 1, wherein the leather is at least one selected from the group consisting of natural leathers, artificial leathers, synthetic leathers, recycled leathers, surface-treated natural leathers, surface-treated artificial leathers, surface-treated synthetic leathers, and surface-treated recycled leathers.

7. The printing method according to claim 1, wherein a ratio (A-B)/A, where A represents bending resistance of the leather before printing and B represents bending resistance of the leather after printing, is 40% or less.

8. The printing method according to claim 1, further comprising drying the leather after the applying the clear ink onto the color ink applied.

9. The printing method according to claim 1, wherein a maximum tensile stress of a dry film of the color ink is 1.2 N/mm² or more and a maximum tensile stress of a dry film of the clear ink is 3.5 N/mm² or more.

10. A printing device for printing an image on a leather with an ink set comprising a color ink and a clear ink, the printing device comprising:
a color ink applying unit configured to apply the color ink; and
a clear ink applying unit configured to apply the clear ink,
wherein the color ink comprises a coloring material, an organic solvent, and a resin and the clear ink comprises an organic solvent, an acrylic resin, and a urethane resin.

11. The printing device according to claim 10, wherein a maximum tensile stress of a dry film of the color ink is 1.2 N/mm² or more and a maximum tensile stress of a dry film of the clear ink is 3.5 N/mm² or more.

12. An ink set for printing an image on a leather as a printing target, the ink set comprising:
a color ink comprising a coloring material, an organic solvent, and a resin; and
a clear ink comprising an organic solvent, an acrylic resin, and a urethane resin.

13. The ink set according to claim 12, wherein a maximum tensile stress of a dry film of the color ink is 1.2 N/mm2 or more and a maximum tensile stress of a dry film of the clear ink is 3.5 N/mm² or more.

14. A printed matter, comprising:
a leather;
a first clear ink film on the leather,
a color ink film on the first clear ink film; and
a second clear ink film on the color ink film,
wherein a ratio (A-B)/A, where A represents bending resistance of the leather before printing and B represents bending resistance of the leather after printing, is 40% or less.
